(19) United States
(12) Patent Application Publication
(10) Pub. No.: US 2026/0213949 A1
(43) Pub. Date: Jul. 23, 2026

(54) TRANSMISSION APPARATUS, RECEPTION APPARATUS, COMMUNICATION SYSTEM, TRANSMISSION METHOD, AND PROGRAM

(71) Applicant: NTT, Inc., Tokyo (JP)

(72) Inventors: Satoshi NAKAMURA, Tokyo (JP); Tsunekazu SAITO, Tokyo (JP); Sakae CHIKARA, Tokyo (JP)

(21) Appl. No.: 19/158,141

(22) PCT Filed: Mar. 30, 2023
(86) PCT No.: PCT/JP2023/013396

§ 371 Date: Aug. 20, 2025

(51) Int. Cl. H04L 9/32

(52) U.S. Cl. CPC H04L 9/3236

(57) ABSTRACT

A transmission device includes: a generation unit that generates, for each divided data, data including divided data generated by dividing transmission data, a hash value calculated from a random number, and a data number of the divided data; and a transmission unit that transmits the data generated by the generation unit to a reception device.

### TECHNICAL FIELD

The present invention relates to a technique for dividing and transmitting data.

### BACKGROUND ART

Public key cryptography has been conventionally used. In public key cryptography, only a small amount Of key data is shared between devices (that is, a secret key is shared in advance using public key cryptography), and actual messages and the like are transmitted and received using symmetric key cryptography while the messages and the like are divided as necessary.

As a division technique, various methods (cipher mode of operation (Non-Patent Literature 1)) are known. However, these methods are for symmetric key cryptography. That is, these methods use a secret key possessed in advance, and cannot be used for public key cryptography that does not have a symmetric key in advance.

### CITATION LIST

### Non-Patent Literature

Non-Patent Literature 1: Cipher specification and cipher mode of operation, posted on “electronic government recommended cipher list”, NIST SP 800-38A https://nvlpubs.nist.gov/nistpubs/Legacy/SP/nistspecialpublication800-38a.pdf

### SUMMARY OF INVENTION

### Technical Problem

With development of quantum computers in recent years, there is a need for post-quantum cryptography capable of withstanding decryption of quantum computers as a public key cryptosystem.

In conventional public key cryptography, only a small amount of key data is shared. However, in post-quantum cryptography, since the size of the key is larger than that in the related art, there is a possibility that the key data cannot be transmitted at a time in an environment with limited communication capacity or calculation resources such as IoT. In this case, it is necessary to divide and transmit the key data.

The related art disclosed in Non-Patent Literature 1 is for symmetric key cryptography and cannot be applied to post-quantum cryptography. In addition, in the related art, in a case where a key is simply divided and transmitted, an efficiency problem occurs due to delay in detection of tampering, loss in order, or the like.

The present invention has been made in view of the above points, and an object of the present invention is to provide a technique for realizing an efficient mechanism capable of detecting tampering or the like at the time of receiving data in a system for dividing and transmitting data.

### Solution to Problem

According to the disclosed technique, there is provided a transmission device including: a generation unit that generates, for each divided data, data including divided data generated by dividing transmission data, a hash value calculated from a random number, and a data number of the divided data; and a transmission unit that transmits the data generated by the generation unit to a reception device.

### Advantageous Effects of Invention

According to the disclosed technique, a technique is provided for realizing an efficient mechanism capable of detecting tampering or the like at the time of receiving data in a system for dividing and transmitting data.

### BRIEF DESCRIPTION OF DRAWINGS

FIG. 1 is a diagram illustrating a configuration example of a communication system.

FIG. 2 is a sequence diagram for explaining an operation of the communication system.

FIG. 3 is a configuration diagram of a transmission device 100.

FIG. 4 is a configuration diagram of a reception device 200.

FIG. 5 is a diagram illustrating a hardware configuration example of each device.

### DESCRIPTION OF EMBODIMENTS

Embodiments of the present invention (present embodiments) will be described below with reference to the drawings. Each of the embodiments described below is merely an example, and embodiments to which the present invention is applied are not limited to the following embodiments.

In the present embodiment, by applying a technique to ensure order and consistency using a hash, to a signature method or a key encapsulation mechanism (KEM) which is public key cryptography, an efficient mechanism capable of detecting tampering or the like at the time of receiving data (that is, ensuring integrity) is realized in a method of dividing and transmitting data, such as a key, due to resource limitations or the like. Hereinafter, the configurations and operations of a system and a device for this mechanism will be described in detail.

### System Configuration Example

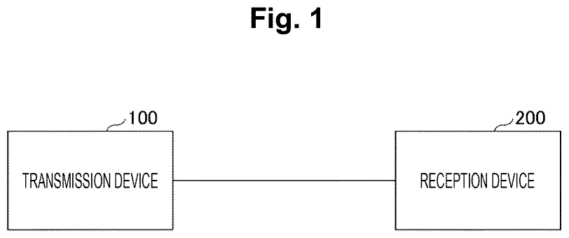

FIG. 1 illustrates a configuration example of a communication system in the present embodiment. As illustrated in FIG. 1, the communication system includes a transmission device 100 and a reception device 200. The transmission device 100 and the reception device 200 can communicate with each other via a network.

It is assumed that one or both of the transmission device 100 and the reception device 200 are, for example, devices with limited functions (resources) such as IoT devices. However, the present invention is not limited to such an assumption, and both the transmission device 100 and the reception device 200 may each be any device.

### Operational Example of System

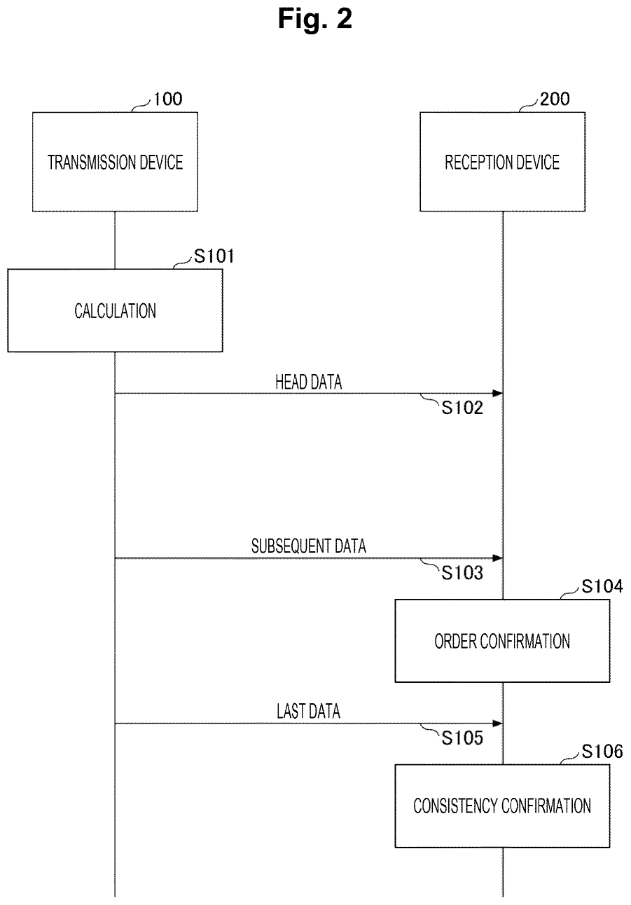

An operational example related to data transmission and reception in the communication system in the present embodiment will be described with reference to a sequence diagram of FIG. 2. Here, since the size of data to be transmitted is large, it is assumed that the transmission device 100 divides and transmits the data. However, the present invention is not limited to such an assumption, and the technique according to the present embodiment can be applied to data of any size.

In addition, data D to be transmitted is KEM encrypted data, signature data, key data, or the like, and the technique according to the present embodiment can be applied to any other types of data.

The data D to be transmitted is set as D:=(D₁, D₂, . . . , and Dₙ). D₁, D₂, . . . , and Dₙ are each divided pieces of data D divided by the transmission device 100. Here, n is the number of divisions. 1, 2, and the like are data numbers.

In S101 (step 101), the transmission device 100 generates a random number r, and calculates h₁=H(r), h₂=H(h₁), . . . , hₙ=H(hₙ₋₁). H is a hash function. With this calculation, the data numbers are linked by hashing before and after the data numbers.

In S102, the transmission device 100 transmits (divided data D₁, hash value hₙ, data number 1, the number of divisions n) to the reception device 200 as head data.

In S103, the transmission device 100 transmits (D₂, hₙ₋₁, 2), (D₃, hₙ₋₂, 3), . . . , and (Dₙ, h₁, n) to the reception device 200 as subsequent data in this order. That is, the transmission device 100 transmits (D₂, hₙ₋₁, 2), and then transmits (D₃, hₙ₋₂, 3). The same applies hereinafter.

In S104, the reception device 104 confirms that H (hₙ₋ₖ)=hₙ₋ₖ₊₁ holds for the received data with k and the received data with k−1 for each data number k (2≤k≤n). With this confirmation, the reception device 200 can confirm that the order of the received data numbers is the correct order. That is, the order can be confirmed. In a case where H(hₙ₋ₖ)=hₙ₋ₖ₊₁ does not hold, for example, the reception device 200 rejects the data.

The order confirmation in S104 may be performed every time the received data (Dₖ, hₙ₋ₖ₊₁, k) is received, or may be collectively performed after a plurality of pieces of received data are received.

In S105, the transmission device 100 transmits a value of (r, H(D) ) to the reception device 200 as last data.

In S106, the reception device 200 confirms that h₁=H(r) holds and also confirms that H((D₁, D₂, . . . , Dₙ) )=H(D) holds, by using the divided data D₁, D₂, . . . , and Dₙ received so far and the (r, H(D) ) received in S105. With S106, the consistency of the divided data can be confirmed.

That is, the relationship between h₁ and a series of pieces of received data can be confirmed by h₁=H(r), and matching of the entire data D with the divided data D₁, D₂, . . . , and Dₙ can be confirmed by H((D₁, D₂, . . . , Dₙ))=H(D). In a case where confirmation of any of the above fails, for example, the reception device 200 rejects the data.

### Supplementary Description

The reception device 200 may confirm the order of the data in the order of the data numbers, reject the other data (data not in the order of the data numbers), and not perform the confirmation.

Further, the transmission device 100 may transmit data other than “head data and last data” without paying attention to the order. In the method according to the present embodiment, since the data numbers are linked using hashes before and after the data numbers, confirmation of the order and the like can be easily performed.

Performing the confirmation in the order of data numbers has an advantage that unnecessary reception can be omitted. However, in a case where UDP is used as a transmission protocol, there is a possibility that the data arrives at the reception device 200 in a state where the order is reversed. Therefore, the transmission device 100 needs to pay attention so that the data arrives at the reception device 200 in order.

On the other hand, in a case of the system in which the data other than the “head data and last data” is transmitted regardless of the order, there is an advantage that the transmission device 100 can transmit the data other than the “head data and the last data” without paying attention.

In a case where transmission is performed regardless of the order, if the hash value is intercepted, there is a risk that data with a previous number thereof may be tampered with, but even in this case, tampering can be finally detected by an original value of a hash value and a hash value of the entire data. However, there is a disadvantage that processing such as confirmation during this time is wasted. When receiving an original random number r indicating the last data, the reception device 200 rejects the data received so far in a case where all the pieces of data are not collected.

### Detailed Example of Transmission Data

An example of data transmitted by the transmission device 100 will be described in more detail. In the following description, “Δ” refers to any number. Values included in (1) head data, (2) subsequent data, and (3) last data are as follows. Here, the data number of the first divided data is 0.
(1) Head data
Data number: 00 (Δ bit)
Fragment ID (Δ bit)
Number of divisions n (Δ bit)
Timeout time (Δ bit)
Divided data: D₁ (variable Δ byte to Δ byte)
Hash value: hₙ
(2) Subsequent data (2nd to n−1th)
Data number: 01 to ΔΔ (Δ bit)
Fragment ID (Δ bit)
Divided data: Dᵢ (2≤i≤n−1)
Hash value: hᵢ (2≤i≤n−1)
(3) Last data
Data number: ΔΔ (Δ bit)
Fragment ID (Δ bit)
Random number: r
Entire hash value: H(D)

### Description of Detailed Example of Transmission Data

A detailed example of the above “(1) head data, (2) subsequent data, and (3) last data” will be described below.

Although depending on the operation, for example, the number of bits to be secured is determined in advance as a fixed length for the data number, the fragment ID, the number of divisions, the timeout time, and the hash value.

The size of the divided data is obtained by subtracting the number of bytes of a fixed length from the number of bytes that can be transmitted at one time. However, the last subsequent data (n−1th) includes remainder data obtained by dividing the last subsequent data by the number of divisions.

Regarding the data number, 00 indicates the first data, and n−1 indicates the last data. The fragment ID is a factor for identifying whether a series of data is the same.

The transmission device 100 can determine the number of divisions from the size of the entire data D, the size of data that can be transmitted at one time, and the required data size of a fixed length.

The timeout time indicates a timeout time between the pieces of data in the case of the sequential transmission system, and indicates a timeout time from transmission of the first data to transmission of the last data in the case of the non-sequential transmission system.

### APPLICATION EXAMPLES

The technique according to the present embodiment can be applied to various fields. Examples 1 and 2 below are shown as examples.

### Example 1

The technique according to the present embodiment can be used for encrypted communication in a smartphone using near field communication (NFC), which is widely used.

In most smartphones, there is a restriction that the size of data that can be transmitted is up to 255 bytes. On the other hand, in a case where post-quantum cryptography is used, data transmission of several kilobytes in size is required.

By using the technique according to the present embodiment, even in a case where there is the restriction above, data can be efficiently transmitted by dividing transmission data, safely transmitting first and last data by NFC, and transmitting intermediate data by another method.

### Example 2

The technique according to the present embodiment can be used in the use of public key cryptography in domain name system security extensions (DNSSEC). Note that the DNSSEC is a technique in which a specification is extended so that authentication of a data creation source and integrity of data can be confirmed with respect to the DNS by using a public key cryptosystem and an electronic signature mechanism.

Conventional DNS packets are determined to be up to 512 bytes in size, and when signature information for DNSSEC (and a signature by post-quantum cryptography) is added to a DNS packet, it becomes difficult to transmit the DNS packet at one time. Therefore, it is possible to comply with DNSSEC by dividing and transmitting data using the technique according to the present embodiment.

### Device Configuration Example

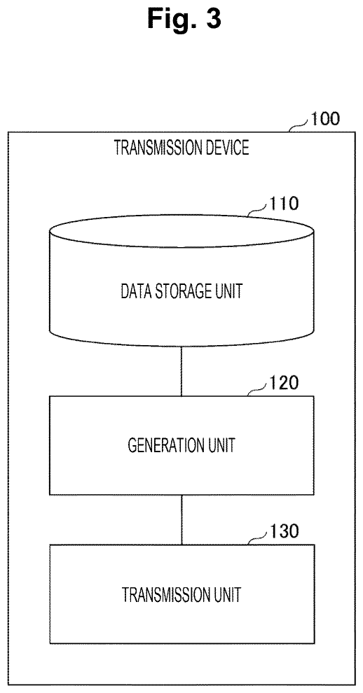

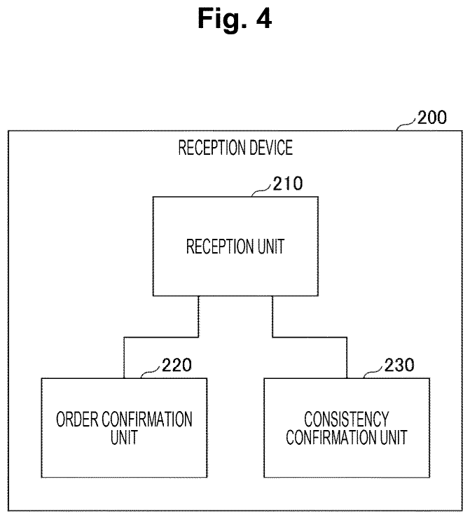

Functional configuration examples of the transmission device 100 and the reception device 200 that execute the operation illustrated in FIG. 2 are illustrated in FIGS. 3 and 4, respectively.

As illustrated in FIG. 3, the transmission device 100 includes a data storage unit 110, a generation unit 120, and a transmission unit 130.

Data D is stored in the data storage unit 110. Note that the data D may be input to the transmission device 100 from the outside.

The generation unit 120 generates the divided data D₁, D₂, . . . , and Dₙ, generates the random number r, and calculates h₁=H(r), h₂=H(h₁), . . . , and hₙ=H(hₙ₋₁). The generation unit 120 generates the head data (divided data D₁, hash value hₙ, data number 1, number of divisions n), the subsequent data (D₂, hₙ₋₁, 2), (D₃, hₙ₋₂, 3), . . . , and (Dₙ, h₁, n), and the last data (r, H(D) ) using the data.

The transmission unit 130 transmits each piece of data generated by the generation unit 120 to the reception device 200.

As illustrated in FIG. 4, the reception device 200 includes a reception unit 210, an order confirmation unit 220, and a consistency confirmation unit 230.

The reception unit 210 receives data transmitted from the transmission device 100. The order confirmation unit 220 confirms whether H(hₙ₋ₖ)=hₙ₋ₖ₊₁ holds to confirm the order of the data.

The consistency confirmation unit 230 confirms whether h₁=H(r) holds and whether H((D₁, D₂, . . . , Dₙ) )=H(D) holds to confirm the consistency of data.

### Hardware Configuration Example

All of the devices (transmission device 100 and reception device 200) described in the present embodiment can be implemented by, for example, causing a computer to execute a program. This computer may be a physical computer or may be a virtual machine on a cloud.

That is, the device can be implemented by executing a program corresponding to the processing to be performed in the device by using hardware resources such as a CPU and a memory included in the computer. The above program can be stored and distributed by being recorded in a computer-readable recording medium (a portable memory or the like). Furthermore, the above program can also be provided through a network such as the Internet or an electronic mail.

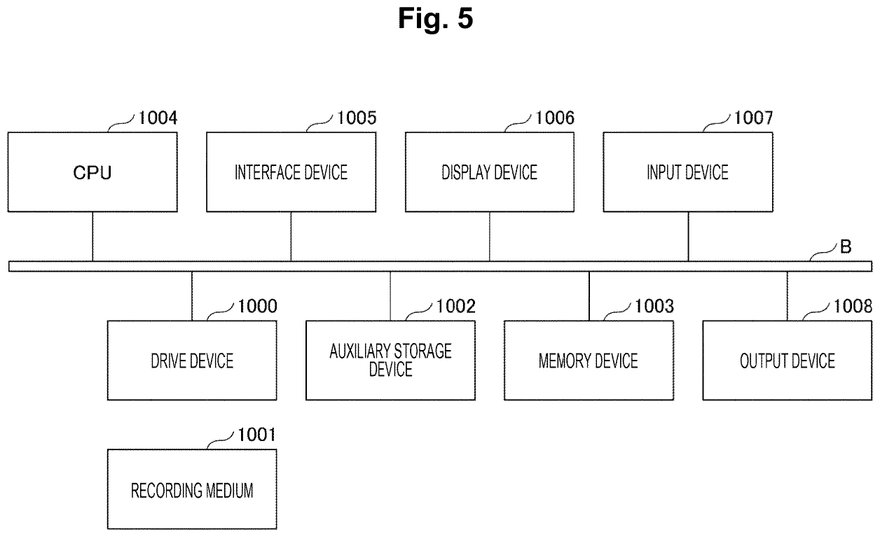

FIG. 5 is a diagram illustrating a hardware configuration example of the computer. The computer in FIG. 5 includes a drive device 1000, an auxiliary storage device 1002, a memory device 1003, a CPU 1004, an interface device 1005, a display device 1006, an input device 1007, and an output device 1008, which are connected to each other by a bus B. Note that the computer may further include a GPU.

The program for implementing the processing in the computer is provided by, for example, a recording medium 1001 such as a CD-ROM or a memory card. When the recording medium 1001 storing the program is set in the drive device 1000, the program is installed from the recording medium 1001 to the auxiliary storage device 1002 via the drive device 1000. However, the program is not necessarily installed from the recording medium 1001 and may be downloaded from another computer via a network. The auxiliary storage device 1002 stores the installed program and also stores necessary files, data, and the like.

In a case where an instruction to start the program is given, the memory device 1003 reads the program from the auxiliary storage device 1002 and stores the program. The CPU 1004 realizes a function related to the device according to the program stored in the memory device 1003. The interface device 1005 is used as an interface for a connection to a network or the like. The display device 1006 displays a graphical user interface (GUI) or the like according to the program. The input device 1007 includes a keyboard and a mouse, a button, a touchscreen, and the like and is used to input various operation instructions. The output device 1008 outputs a computing result.

### Regarding Effects of Embodiment

In recent years, the encryption technique has been increasingly used in an environment where the amount of transmission and reception of data is relatively limited, such as applications or IoT using smartphones. In addition, there is also a concern that cryptography may be compromised due to progress in research and development of quantum computers, and it is expected that using post-quantum cryptography will lead to an increase in situations where data needs to be further divided.

By using the technique according to the present embodiment, even if a fraudulent act such as tampering is performed when dividing data, it is possible to detect the tampering or the like and reject data by a relatively low-cost process of calculating a hash chain, and therefore, it can be expected to contribute to improvement of efficiency in a case where an attack such as tampering is expected.

With regard to above embodiments, the following clauses are further disclosed.

### Clauses

(Clause 1)

A transmission device including:
a generation unit that generates, for each divided data, data including divided data generated by dividing transmission data, a hash value calculated from a random number, and a data number of the divided data; and
a transmission unit that transmits the data generated by the generation unit to a reception device.
(Clause 2)

The transmission device according to Clause 1,
wherein in a case where the number of divisions of the transmission data is n and a data number of the data is k, a hash value hn−k+1 in the data is a hash value of a hash value hn−k, and a hash value in data with a data number n is a hash value of the random number, and
the transmission unit transmits the random number and a hash value of the transmission data as last data.
(Clause 3)

A reception device including:
a reception unit that receives, for each divided data, data including divided data generated by dividing transmission data, a hash value calculated from a random number, and a data number of the divided data; and
an order confirmation unit that confirms order between first received data with a certain data number and second received data with a data number immediately before the data number by using a hash value in the first received data and a hash value in the second received data.
(Clause 4)

The reception device according to Clause 3, further including:
a consistency confirmation unit,
in which in a case where the number of divisions of the transmission data is n and a data number of the data is k, a hash value hn−k+1 in the data is a hash value of a hash value hn−k, and a hash value in data with a data number n is a hash value of the random number,
the reception unit receives the random number and a hash value of the transmission data as last data, the order confirmation unit confirms order between received data with a data number k and received data with data number k−1 by using the hash value hn−k+1 and the hash value hn−k, and
the consistency confirmation unit confirms whether or not a hash value in received data with a data number n is equal to the hash value of the random number and whether or not a hash value in divided data of all received data is equal to the hash value of the transmission data.
(Clause 5)

A communication system including:
the transmission device according to Clause 1 or 2; and
the reception device according to Clause 3 or 4.
(Clause 6)

A transmission method executed by a transmission device including:
a generation step of generating, for each divided data, data including divided data generated by dividing transmission data, a hash value calculated from a random number, and a data number of the divided data; and
a transmission step of transmitting the data generated in the generation step to a reception device.
(Clause 7)

A non-transitory storage medium that stores a program for causing a computer to function as each unit in the transmission device according to clause 1 or 2.
(Clause 8)

A non-transitory storage medium that stores a program for causing a computer to function as each unit in the reception device according to clause 3 or 4.

Although the present embodiment has been described above, the present invention is not limited to such a specific embodiment, and various modifications and changes can be made within the scope of the concept of the present invention disclosed in the claims.

### REFERENCE SIGNS LIST

100 Transmission device
110 Data storage unit
120 Generation unit
130 Transmission unit
200 Reception device
210 Reception unit
220 Order confirmation unit
230 Consistency confirmation unit
1001 Recording medium
1002 Auxiliary storage device
1003 Memory device
1004 CPU
1005 Interface device
1006 Display device
1007 Input device
1008 Output device

1. A transmission apparatus comprising:
circuitry configured to:
divide transmission data into data items;
create, for each data item of the data items, generation data including:
the data item,
a hash value calculated from a random number, and
a data number of the data item; and
transmit the generation data to a reception apparatus.

2. The transmission apparatus according to claim 1, wherein when n is the number of divisions of the transmission data and k is a data number of the generation data corresponding to the data number of the data item,
hₙ₋ₖ₊₁ represents the hash value of the (n−k+1)-th generation data that is identical to the hash value that is obtained by applying a hash function to a hash value hₙ₋ₖ of the (n−k)-th generation data,
the hash value of the generation data with a data number n is used as the random number,
2≤k≤n is satisfied, and
k and n are integers, and
wherein the circuitry is configured to transmit the random number and a hash value of the transmission data as last data.

3. A reception apparatus comprising:
circuitry configured to:
receive, for each data item of data items into which transmission data is divided, generation data including:
the data item,
a hash value calculated from a random number, and
a data number of the data item; and
confirm a sequential order between the generation data received with a predetermined data number and the generation data received with a data number immediately before the predetermined data number, by using (i) the hash value of the generation data received with the predetermined data number and (ii) the hash value of the generation data received with the data number immediately before the predetermined data number.

4. The reception apparatus according to claim 3,
wherein when n is the number of divisions of the transmission data and k is a data number of the generation data corresponding to the data number of the data item,
hₙ₋ₖ₊1 represents the hash value of the (n−k+1)-th generation data that is identical to the hash value that is obtained by applying a hash function to a hash value hₙ₋ₖ
of the (n−k)-th generation data,
the hash value of the generation data with a data number n is used as the random number,
2≤k≤n is satisfied, and
k and n are integers, and
wherein the circuitry is configured to:
receive the random number and a hash value of the transmission data as last data;
confirm the sequential order between the generation data received with the data number k and the generation data received with data number k−1, by using the hash value hₙ₋ₖ₊₁ and the hash value hₙ₋ₖ; and
determine whether the hash value of the generation data received with the data number n is identical to the random number; and
determine whether a hash value that is obtained by applying a hash function to the data items of all received generation data is identical to the hash value of the transmission data.

5. A communication system comprising:
a transmission apparatus including circuitry configured to:
divide transmission data into data items;
create, for each data item of the data items, generation data including:
the data item,
a hash value calculated from a random number, and
a data number of the data item; and
transmit the generation data to the reception apparatus of claim 3; and
the reception apparatus.

6. A transmission method executed by a transmission apparatus, comprising:
dividing transmission data into data items;
creating for each data item of the data items, generation data including:
the data item,
a hash value calculated from a random number, and
a data number of the data item; and
transmitting the generation data to a reception apparatus.

7. A non-transitory computer readable storage medium storing a program configured for causing a computer to execute the transmission method of claim 6.

8. (canceled)
